(19) United States
(12) Patent Application Publication
(10) Pub. No.: US 2005/0241892 A1
(43) Pub. Date: Nov. 3, 2005

(54) Rear bicycle brake

(76) Inventor: Szu-Fang Tsai, Chang-Hua Hsien (TW)

Correspondence Address: Leong C. LEI;PMB#1008, 1867 Ygnacio Valley Rd., Walnut Creek, CA, 94598, US

(21) Appl. No.: 10/834,903

(22) Filed: Apr. 30, 2004

(51) Int. Cl. B62L 1/02

(52) U.S. Cl. 188/24.12; 188/2 D

(57) ABSTRACT

An improved structure of a rear bicycle brake comprised of two brake arms pivoted respectively with their axes to a bicycle seat tube; both lower sections of axes extending in symmetric to define a clamping part fixed with a brake block to clamp the rim of the rear wheel characterized by that the upper section of the primary brake arm extending at an inclination to form a pull arm; and that of the second brake arm extending in a curve to form a press arm; a slant end opening at the secondary brake arm for the inner cord of the brake cable to penetrate through, the cord being fastened at the terminal of the primary brake arm to accommodate the brake cable coming in a non-longitudinally straight orientation for achieving the insertion at a certain inclination to apply the optimal brake.

### BACKGROUND OF THE INVENTION

(a) Technical Field of the Invention

The present invention is related to a rear bicycle brake, and more particularly to a cable stayed brake for a free style bicycle.

(b) Description of the Prior Art

Referring to FIG. 1 of the accompanying drawings, a free style bicycle to facilitate the operation for performance has a shorter frame by reducing the length of the chain stay L.

The spacing between two clamps of the rear brake is getting smaller as illustrated in FIG. 2 due to a shorter chain stay; therefore the clamping angle θ is far less than 90° (usually, 90° is the optimal clamping angle in applying a rear brake) to compromise its brake efficiency.

### SUMMARY OF THE INVENTION

The primary purpose of the present invention is to provide an improved structure of a rear brake for a bicycle to accommodate any brake cable not longitudinally straight arranged to any style of bicycle for the brake cable to comfortably penetrate at a certain inclination. To achieve the purpose, the rear brake is comprised of a primary and a secondary brake arms; axes of both arms are respectively pivoted to the seat tube of the bicycle and the lower sections respectively of two axes extending in symmetric to each define a clamping portion whereon a brake block is fixed to clamp the rim of the rear wheel. Wherein, the upper section of the primary brake arm extends at a certain inclination to form a pull arm; and that of the secondary brake arm extends in a curve to form a press arm; an inclined end opening is provided to the press arm to receive the insertion of an inner cord of the brake cable and fastened of the inner cord at the terminal of the primary brake arm to permit the insertion of the inner cord at a certain inclination.

Another purpose of the present invention is to provide an improved structure of a rear brake, wherein, depending on the style of the bicycle or the spatial demand of the brake cable connected, an L-shape guide tube for brake cable is connected to the inclined end opening of the press arm of the secondary brake arm without compromising the teaching of the present invention.

Another purpose yet of the present invention is to provide an improved structure of a rear brake, wherein, as the entangled of the brake arms with the running gear panel may present danger to the rider of the bicycle, a retainer is provided on the back of the middle section of the primary brake arm to interlock both brake arm in their elastic expansion status when the brake cable suddenly breaks up so to prevent the brake arms from being locked in the running gear panel due to the absence of being expanded by the brake cable.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a conventional free style bicycle.

FIG. 2 is a schematic view showing a rear brake of the free style bicycle of the prior art.

FIG. 3 is a schematic view showing the application of a rear brake of the present invention.

FIG. 4 is a view showing an assembly of a preferred embodiment of the present invention.

FIG. 5 is a sectional view of the assembly of the preferred embodiment of the present invention.

FIG. 6 is a schematic view showing another preferred embodiment of the present invention.

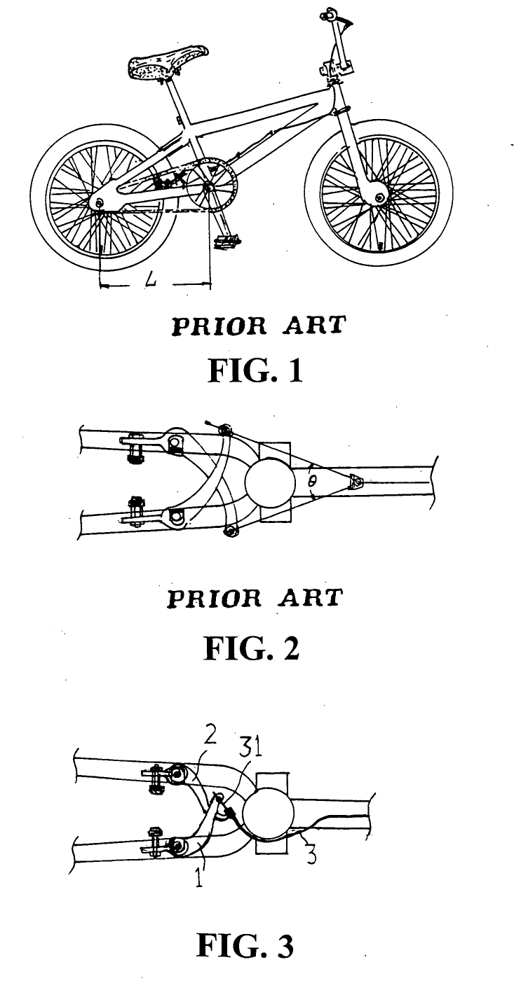

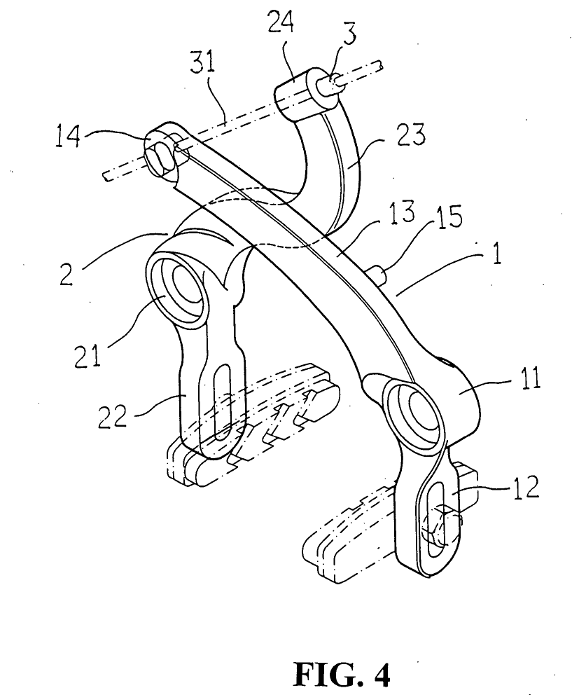

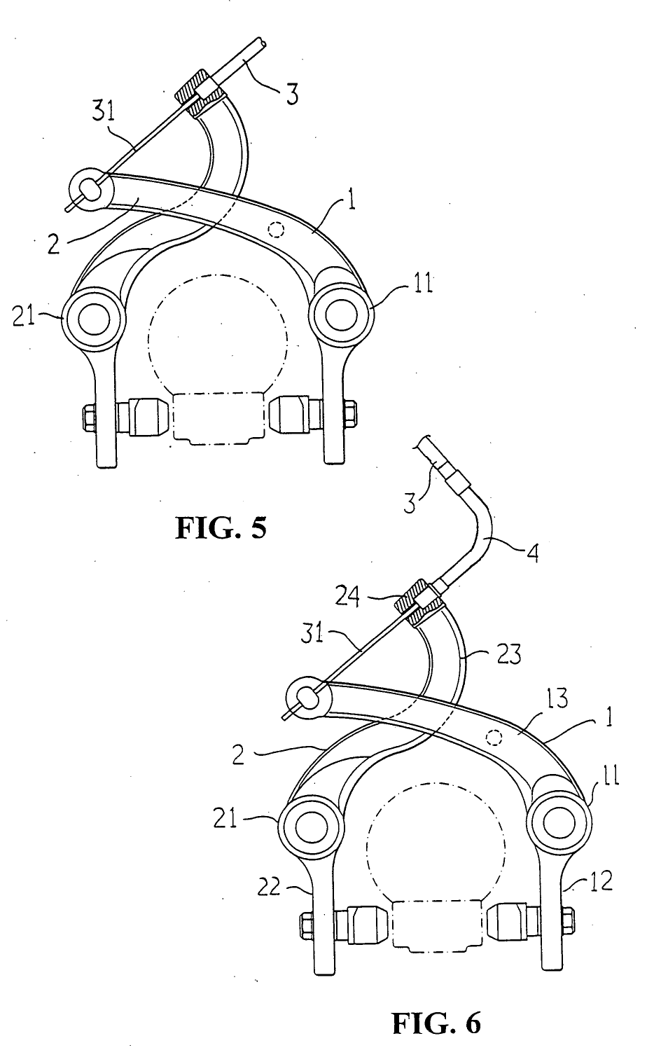

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to the accompanying drawings of the present invention, a preferred embodiment of an improved structure of a rear brake of the present invention is comprised of a primary brake arm 1 and a secondary brake arm 2; both of the primary and the secondary brake arms 1, 2 are pivoted respectively with their axes 11, 21 to a seat stand of a bicycle; and two clamping portions 12, 22 respectively extend from the lower sections of both axes 11, 21 to be fixed with a brake block to clamp on the rim of the rear wheel of the bicycle. Wherein, the upper section of the primary brake arm extends at a certain inclination to form a pull arm 13, and the upper section of the secondary brake arm 2 extends at a curvature to form a press arm 23. An inclined end opening 24 is provided to the press arm 23 for an inner cord 31 of a brake cable 3 to penetrate through and fastened at a terminal 14 of the primary brake arm 1. Consequently, the inclined installation of the end opening 24 of the press arm 23 of the secondary brake arm 2 satisfies the inclined insertion of the brake cable 3 coming non-longitudinally straight from a free style bicycle or any other type of bicycle to provide the optimal rear brake.

As illustrated in FIG. 6, depending on the style of the bicycle and the spatial demand for the physical connection to the brake cable 3, the inclined end opening of the press arm 23 to the secondary brake arm 2 is connected to an L-shape brake cable guide tube 4 without compromising the teaching of the present invention.

Furthermore, as the entangled of the brake arms with the running gear panel may present danger to the rider of the bicycle, a retainer 15 is disposed on the back of the middle section of the primary brake arm 1 to interlock both brake arm in their elastic expansion status when the brake cable 3 suddenly breaks up so to prevent the brake arms 1, and 2 from being locked in the running gear panel due to the absence of being expanded by the brake cable.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. A rear brake for a bicycle comprising:
a primary brake arm having a first axle holding portion pivotally connected with a seat stand of the bicycle, said primary brake having a first clamping portion extending from a lower portion of said first axle holding portion, said first clamping portion being provided with a first brake block, said primary brake arm having an upper portion extending at a certain inclination to form a pull arm, said pull arm having an end provided with a terminal for receiving an end of a brake cable; and
a secondary brake arm having a second axle holding portion pivotally connected with a seat stand of the bicycle, said secondary brake arm having a second clamping portion extending from a lower portion of said second axle holding portion; said second portion being provided with a second brake block, said secondary brake arm having an upper section extending at a curvature to form a press arm, said press arm having an upper end formed with an inclined end opening for receiving said brake cable;
whereby said primary brake arm and said secondary brake arm are two separate members and are only connected by said brake cable thereby making it easier to manufacture and lowering cost.

5. The rear brake for a bicycle as claimed in claim 4, wherein said primary brake arm has an intermediate portion provided with a retainer.

6. The rear brake for a bicycle as claimed in claim 4, wherein said inclined end opening is connected with an L-shape brake cable guide tube.
